(19) United States
(12) Patent Application Publication
(10) Pub. No.: US 2021/0343184 A1
(43) Pub. Date: Nov. 4, 2021

(54) MECHANICAL ANALOG OF ELECTRONICS

(71) Applicant: Paul Garrett Boswell, Shoreview, MN (US)

(72) Inventor: Paul Garrett Boswell, Shoreview, MN (US)

(21) Appl. No.: 17/242,878

(22) Filed: Apr. 28, 2021

Related U.S. Application Data
(60) Provisional application No. 63/017,260, filed on Apr. 29, 2020.

(51) Int. Cl. G09B 23/18; F16H 48/10

(52) U.S. Cl. CPC G09B 23/185; F16H 48/10; G09B 23/181

(57) ABSTRACT

A mechanical analog of electronics configured to enable the construction of a mechanical equivalent of an electrical circuit, the mechanical analog of electronics, including two or more repositionable rotating members, each of rotating member representing a mechanical equivalent of a component of an electrical circuit, wherein the rotating members are operably coupled together by at least one of a chain, belt, string, or gear coupling.

### RELATED APPLICATION INFORMATION

This application claims the benefit of U.S. Provisional Application No. 63/017,260, filed Apr. 29, 2020, the contents of which are fully incorporated herein by reference.

### TECHNICAL FIELD

The present disclosure relates generally a mechanical analog of electronics, and more particularly a mechanical analog of electronics with repositionable members that can be configured to build a mechanical version of virtually any electronics circuit.

### BACKGROUND

Electronics is a cornerstone of modern technology, but it is an especially difficult subject to learn and teach beyond the most basic concepts. It is not possible to see or feel electrons as they flow through circuits, so it is abstract and difficult to relate to. Instead, electronics must be understood through mathematical models that frequently require advanced math, limiting the audience to which electronics can be taught.

One powerful way to aid learning electronics is to think of electronic circuits in terms of a physical analog, that is, a physical representation that behaves just like electronics. The purpose of a physical analog is to make electronics more understandable by relating it to tangible, familiar experiences.

Analogs of electronics have been described in the past using fluids (gas or liquid) as the counterpart to electrons. Fluids are an obvious analog because fluid flows through pipes in much the same way as electrons flow through wires. For example, if water is pushed through a pipe that splits into two pipes, some of the water goes through one pipe and some of it goes through the other. The flow and pressure of water in each pipe can be described using the same relationships one would use to calculate current and voltage in a branching electrical circuit.

Unfortunately, fluid analogs (gas or liquid) have a number of major limitations. For one, you cannot see the movement of fluids through a tube. It looks the same whether it is moving or still. Additionally, liquids have viscosity that causes significant resistance when pushed through tubes, while gases are compressible, causing significant capacitance in tubes. Furthermore, when using gases, a great deal of power is lost from hysteresis during compression and expansion. And on a practical level, it would be very difficult to design a liquid-based system that is not messy or a gas-based system that is not leaky.

### SUMMARY OF THE DISCLOSURE

The present invention describes a system for building reconfigurable, mechanical analogs of electronic circuits—a physical representation that uses reconfigurable mechanical components in place of their electronic equivalents. The invention includes a mechanical analog of a battery, a mechanical resistor, a mechanical capacitor, a mechanical inductor, a mechanical switch, a mechanical transistor, a mechanical diode, a mechanical junction, and an expandable, reconfigurable base to which the parts attach to build mechanical analogs of electronic circuits. Its purpose is to make electronics tangible and easy to understand: The force of voltage can be felt, the flow of current can be seen (and heard), and the behavior of electronic circuits can be understood intuitively, with only basic math. One can also perturb a circuit and see its effect simply by touching it: touch a part to add resistance or push on it to add voltage.

One embodiment of the present disclosure provides a mechanical analog of electronics configured to enable the construction of a mechanical equivalent of an electrical circuit, the mechanical analog of electronics including two or more repositionable rotating members, each of rotating member representing a mechanical equivalent of a component of an electrical circuit, wherein the rotating members are operably coupled together by at least one of a chain, belt, string, or gear coupling.

In one embodiment, each rotating member represents a mechanical analog of at least one of an electrical junction, resistor, capacitor, battery, switch, transistor, inductor, diode, or tone generator. In one embodiment, at least one of the rotating members represents a mechanical analog of an electrical junction comprising a differential gear system including a first gear, sprocket or pulley, a second gear, sprocket or pulley and a third gear, sprocket or pulley, wherein a velocity on a perimeter of the first gear, sprocket or pulley is equal to a velocity on a perimeter of the second gear, sprocket or pulley plus a velocity on a perimeter of the third gear, sprocket or pulley. In one embodiment, at least one of the rotating members represents a mechanical analog of electrical resistor comprising at least one rotatable gear, sprocket or pulley operably coupled to a spindle, and a viscous fluid damper configured to enable the spindle to rotate with a fixed resistance as a result of shearing of the viscous fluid.

In one embodiment, at least one of the rotating members represents a mechanical analog of a mechanical capacitor configured to enable measurement of a voltage in a mechanical equivalent of an electrical circuit, the mechanical capacitor comprising at least one rotatable gear, sprocket or pulley and a torsion spring, wherein rotation of the at least one rotatable gear, sprocket or pulley causes energy to be stored in the torsion spring, the mechanical capacitor further comprising an indicator configured to display the amount of force (the mechanical equivalent to voltage) acting on the mechanical capacitor. In one embodiment, at least one of the rotating members represents a mechanical tone generator configured to enable measurement of the flow of current in a mechanical equivalent of electrical circuit, the mechanical tone generator comprising at least one rotating gear, sprocket or pulley and a diaphragm, wherein rotation of the at least one rotatable gear, sprocket or pulley causes a vibration in the diaphragm resulting in an audible noise, wherein a pitch of the audible noise varies according to an angular velocity of the at least one gear, sprocket or pulley.

In one embodiment, at least one of the rotating members represents a mechanical analog of electrical transistor comprising a first rotatable gear, sprocket or pulley, a second rotatable gear, sprocket or pulley and a brake mechanism operably coupled to the second rotatable gear, sprocket or pulley configured to provide a resistance to rotation of the second rotatable gear, sprocket or pulley, wherein rotation of the first rotatable gear, sprocket or pulley causes at least one of an increase or a decrease in the resistance to rotation of the second rotatable gear, sprocket or pulley. In one embodiment, the mechanical analog of electronics further includes a ferritic base, wherein each of the rotating members is configured to rotate relative to a stationary magnetic base selectively and magnetically coupleable to the ferritic base.

Another embodiment of the present disclosure provides a mechanical analog of an electrical junction including a differential gear system comprising a first gear, sprocket or pulley, a second gear, sprocket or pulley and a third gear, sprocket or pulley, wherein a velocity on a perimeter of the first gear, sprocket or pulley is equal to a velocity on a perimeter of the second gear, sprocket or pulley plus a velocity on a perimeter of the third gear, sprocket or pulley.

In one embodiment, the differential gear system comprises a sun and planetary gear system. In one embodiment, the velocity of the perimeter of the first gear, sprocket or pulley represents an electrical current flowing into an electrical junction, and the velocity of the perimeter of the second third gear, sprocket or pulley and the velocity of the perimeter of the third gear, sprocket or pulley represent electrical currents flowing out of the electrical junction. In one embodiment, the first gear, sprocket or pulley is three times larger than the third gear, sprocket or pulley. In one embodiment, the second gear, sprocket or pulley is two times larger than the third gear, sprocket or pulley. In one embodiment, the mechanical analog of electrical junction further includes a ferritic base, wherein the differential gear system is configured to rotate relative to a stationary magnetic base selectively and magnetically coupleable to the ferritic base.

Another embodiment of the present disclosure provides a mechanical analog of electronics configured to enable the construction of a mechanical equivalent of an electrical circuit, the mechanical analog of electronics including at least one rotating member representing a mechanical equivalent of a component of an electrical circuit, wherein the at least one rotating member is configured to rotate relative to a stationary magnetic base, and a ferritic base, wherein the at least one rotating members selectively, magnetically coupleable to the ferritic base.

In one embodiment, the at least one rotating member represents a mechanical analog of an electrical junction comprising a differential gear system including a first sprocket, a second sprocket and a third sprocket, wherein a velocity on a perimeter of the first sprocket is equal to a velocity on a perimeter of the second sprocket plus a velocity on a perimeter of the third sprocket. In one embodiment, the at least one rotating member represents a mechanical analog of electrical resistor comprising at least one rotatable gear, sprocket or pulley operably coupled to a spindle, and a viscous fluid damper configured to enable the spindle to rotate with a fixed resistance as a result of shearing of the viscous fluid.

In one embodiment, the at least one rotating member represents a mechanical analog of a mechanical capacitor configured to enable measurement of a voltage in a mechanical equivalent of an electrical circuit, the mechanical capacitor comprising at least one rotatable gear, sprocket or pulley and a torsion spring, wherein rotation of the at least one rotatable gear, sprocket or pulley causes energy to be stored in the torsion spring, the mechanical capacitor further comprising an indicator configured to display the force (the mechanical equivalent to voltage) acting on the capacitor. In one embodiment, the at least one of the rotating member represents a mechanical tone generator configured to enable measurement of the flow of current in a mechanical equivalent of electrical circuit, the mechanical tone generator comprising at least one rotating gear, sprocket or pulley and a diaphragm, wherein rotation of the at least one rotatable gear, sprocket or pulley causes a vibration in the diaphragm resulting in an audible noise, wherein a pitch of the audible noise varies according to an angular velocity of the at least one gear, sprocket or pulley. In one embodiment, the at least one rotating members represents a mechanical analog of electrical transistor comprising a first rotatable gear, sprocket or pulley, a second rotatable gear, sprocket or pulley and a brake mechanism operably coupled to the second rotatable gear, sprocket or pulley configured to provide a resistance to rotation of the second rotatable gear, sprocket or pulley, wherein rotation of the first rotatable gear, sprocket or pulley causes at least one of an increase or a decrease in the resistance to rotation of the second rotatable gear, sprocket or pulley.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1A is a perspective view depicting a mechanical analog of an electronic junction, in accordance with an embodiment of the disclosure.

FIG. 1B is the symbol for the mechanical junction of FIG. 1A, which is the same as that for an electronic junction, in accordance with an embodiment of the disclosure.

FIG. 1C is a partially exploded, front perspective view of the mechanical analog of an electronic junction of FIG. 1A, in accordance with an embodiment of the disclosure.

FIG. 2A is a perspective view depicting a mechanical analog of an electronic resistor, in accordance with an embodiment of the disclosure.

FIG. 2B is the symbol for the mechanical resistor of FIG. 2A, which is the same as that for an electronic resistor, in accordance with an embodiment of the disclosure.

FIG. 2C is a partially exploded, front perspective view of the mechanical resistor of FIG. 2A, in accordance with an embodiment of the disclosure.

FIG. 3A is a perspective view depicting a mechanical analog of an electronic capacitor that doubles as a voltmeter, in accordance with an embodiment of the disclosure.

The FIG. 3B is a top view depicting the mechanical capacitor of FIG. 3A, which shows the voltage indicator, in accordance with an embodiment of the disclosure.

FIG. 3C is the symbol for the mechanical capacitor of FIG. 3A, which is the same as that for an electronic resistor, in accordance with an embodiment of the disclosure.

FIG. 3D is a partially exploded, front perspective view of the mechanical capacitor of FIG. 3A, in accordance with an embodiment of the disclosure.

FIG. 4A is a perspective view depicting a mechanical analog of an electronic battery, in accordance with an embodiment of the disclosure.

FIG. 4B is a top view depicting the mechanical battery of FIG. 4A, in accordance with an embodiment of the disclosure.

FIG. 4C is the symbol for the mechanical battery of FIG. 4A, which is the same as that for an electronic voltage source, in accordance with an embodiment of the disclosure.

FIG. 5A is a perspective view depicting a mechanical analog of an electronic push button switch, in accordance with an embodiment of the disclosure.

FIG. 5B is the symbol for the mechanical switch of FIG. 5A, which is the same as that for an electronic switch, in accordance with an embodiment of the disclosure.

FIG. 5C is a partially exploded, front perspective view of the mechanical switch of FIG. 5A, in accordance with an embodiment of the disclosure.

FIG. 6A is a perspective view depicting a mechanical analog of an electronic transistor, in accordance with an embodiment of the disclosure.

FIG. 6B is a front view depicting the mechanical transistor of FIG. 6A, in accordance with an embodiment of the disclosure.

FIG. 6C is the symbol for the mechanical transistor of FIG. 6A, which is similar to that for an electronic field effect transistor, in accordance with an embodiment of the disclosure.

FIG. 6D is a partially exploded, front perspective view of the mechanical transistor of FIG. 6A, in accordance with an embodiment of the disclosure.

FIG. 7A is a front view depicting a mechanical analog of an electronic inductor, in accordance with an embodiment of the disclosure.

FIG. 7B is the symbol for the mechanical inductor of FIG. 7A, which is the same as that for an electronic inductor, in accordance with embodiments of the disclosure.

FIG. 7C is a partially exploded, front perspective view of the mechanical inductor of FIG. 7A, in accordance with an embodiment of the disclosure.

FIG. 8A is a perspective view depicting a mechanical analog of an electronic diode, in accordance with an embodiment of the disclosure.

FIG. 8B is the symbol for the mechanical diode of FIG. 8A, which is the same as that for an electronic diode, in accordance with an embodiment of the disclosure.

FIG. 8C is a partially exploded, front perspective view of the mechanical diode of FIG. 8A, in accordance with an embodiment of the disclosure.

FIG. 9A is a perspective view depicting a mechanical analog of an electronic, voltage-dependent tone generator, in accordance with an embodiment of the disclosure.

FIG. 9B is the symbol for the mechanical tone generator of FIG. 9A.

FIG. 9C is a partially exploded, front perspective view of the mechanical tone generator of FIG. 9A, in accordance with an embodiment of the disclosure.

FIG. 10A is a perspective view depicting a simple mechanical circuit including a mechanical battery and a mechanical resistor, in accordance with an embodiment of the disclosure.

FIG. 10B is a diagram of the mechanical circuit of FIG. 10A, in accordance with an embodiment of the disclosure.

FIG. 10C is a simplified diagram of the mechanical circuit of FIG. 10A, in accordance with an embodiment of the disclosure.

FIG. 11A is a top view of a mechanical, parallel circuit, in which a junction splits a current from a battery between two resistors, in accordance with an embodiment of the disclosure.

FIG. 11B is a diagram of the mechanical circuit of FIG. 11A, in accordance with an embodiment of the disclosure.

FIG. 12A is a top view of a mechanical NOT gate, in which S1 is pushed down closing the circuit, and a voltmeter of C1 shows 0 V, in accordance with an embodiment of the disclosure.

FIG. 12B is a diagram of the mechanical circuit of FIG. 12A, in accordance with an embodiment of the disclosure.

FIG. 12C is a top view of a mechanical NOT gate, in which S1 is not pushed down, thus the circuit is open, and a voltmeter of C1 shows 7 V, in accordance with an embodiment of the disclosure.

FIG. 12D is a diagram of the mechanical circuit of FIG. 12C, in accordance with an embodiment of the disclosure.

FIG. 13A is a top view of a mechanical oscillator circuit, in accordance with an embodiment of the disclosure.

FIG. 13B is a diagram of the mechanical oscillator circuit of FIG. 13A, in accordance with an embodiment of the disclosure.

FIG. 13C is a graph showing an output of transistor T1 and a voltmeter of capacitor C1 over time as the circuit of FIG. 13B runs, in accordance with an embodiment of the disclosure.

FIG. 14A is a top view of a mechanical delay circuit, in accordance with an embodiment of the disclosure.

FIG. 14B is a diagram of the delay circuit of FIG. 14A, in accordance with an embodiment of the disclosure.

FIG. 14C is a graph showing an input and resulting output of the delay circuit shown in FIG. 14A, in accordance with an embodiment of the disclosure.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

The mechanical analog will be described shortly, but first it is necessary to define units to describe the mechanical equivalent of electrical voltage, current, capacitance, and inductance. The mechanical analog of a Volt is the Spin Volt (SV), that of the amp is the Spin Amp (SA), that of the Ohm is the Spin Ohm (SΩ), that of the Farad is the Spin Farad (SF), and that of the Henry is the Spin Henry (SH). The key link between the mechanical units and the electronic units is that 1 Coulomb of charge is arbitrarily defined to equal 10 m of chain. From that, all the other units can be derived. For instance, one Spin Volt can be derived to equal 0.1 N.

A major challenge of designing a mechanical analog to electronics is a ubiquitous component that is often overlooked: the electrical junction (i.e., a point where one wire branches into two). When a wire carrying electrical current branches from one path into two paths, the current splits. Some fraction of the current goes in one path and the rest of the current goes in the other. That is, I1=I2+I3.

If you try to use a moving chain as an analog to electron flow, how do you physically split the chain as paths branch? Even if you could slice the chain in half as it ran through the junction, the two halves of the chain would move at the same speed after the split as before the split, and I1 would not equal I2+I3.

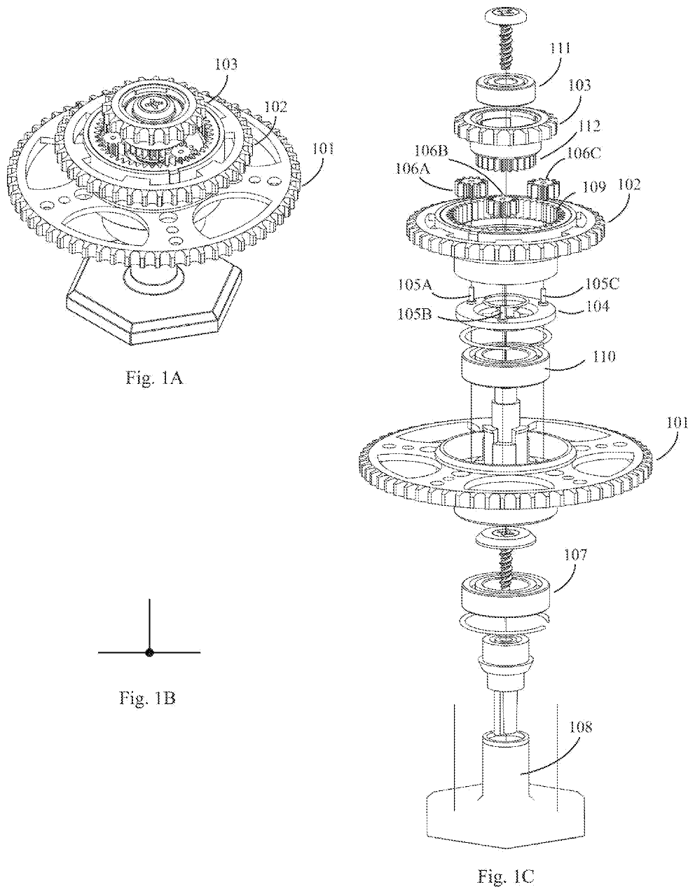

The present invention solves this problem by use of a differential gear system (an embodiment of which is shown in FIG. 1A), which is the analog of an electronic junction. This mechanical junction is designed in such a way that the speed of chain running along the three sprockets 101-103 follows the equation I1=I2+I3, where I1 is the speed of chain along the bottom sprocket 101, I2 is the speed of chain along the middle sprocket 102, and I3 is the speed of chain along the top sprocket 103.

The mechanical junction embodied in FIG. 1A/FIG. 1C uses epicyclic gears to create the differential gear system. A magnetic base 108 is attached to the inner ring of bearing 107. The outer ring of bearing 107 is attached to the bottom sprocket 101, allowing it to rotate relative to the magnetic base. The bottom sprocket 101 is connected to the planetary gear carrier 104, on which three planetary gears 106A-106C rotate on axles 105A-105C. The middle sprocket 102 rotates on bearing 110 and is attached to the ring gear 109. Ring gear 109 meshes with the three planetary gears 106A-106C. The top sprocket 103 rotates on bearing 111 and is attached to sun gear 112. Sun gear 112 meshes with planetary gears 106A-106C.

The gear ratios of the epicyclic gears constrain the three sprockets to turn with the following relationship: 3ω₁=2ω₂+Ω₃, where ω₁ is the angular velocity of the bottom sprocket 101, ω₂ is the angular velocity of the middle sprocket 102, and ω₃ is the angular velocity of the top sprocket 103. In order to make the speed of chain running along the three sprockets constrained to the desired equation I1=I2+I3, the diameter of the bottom sprocket 101 is three-fold larger than the top sprocket 101, and the diameter of the middle sprocket 102 is two-fold larger than the top sprocket 103.

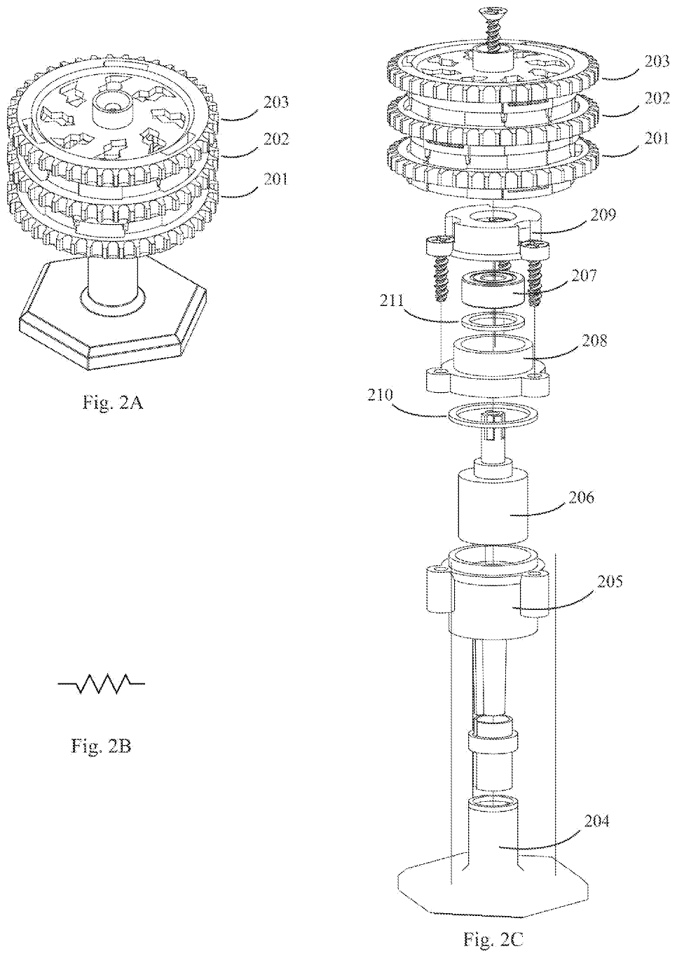

Mechanical analogs of other electronic components are also included in this invention. An embodiment of a mechanical resistor is shown in FIG. 2A. The purpose of the mechanical resistor is to provide constant resistance to the movement of chain, regardless of the speed the chain is moving along the sprocket. Like the mechanical junction, the mechanical resistor also has three sprockets 201-203, but in this part, they are connected together and all turn as one unit.

FIG. 2C shows an exploded view of the mechanical resistor. A magnetic base 204 is connected to the resistor body 205, which contains a cavity open on top. The cavity contains a viscous fluid, ideally a Newtonian fluid like silicone oil. A cylindrical spindle 206 is suspended in the cavity, leaving a thin layer of the viscous fluid between the spindle 206 and the body 205. The spindle is held in place by sealed bearing 207, which allows the spindle to rotate, but with a fixed resistance to rotation as a result of shearing of the viscous fluid. To adjust the resistance to rotation, either the viscosity of the fluid can be adjusted or the size/shape of the cavity 205 and spindle 206 can be adjusted. The bearing 207 is sandwiched between parts 208 and 209 to form a cap that is screwed onto the resistor body 205 and sealed via rubber washers 210 and 211. The sprocket assembly 201/202/203 is screwed onto the spindle 206, thus yielding sprockets with a fixed resistance to rotation.

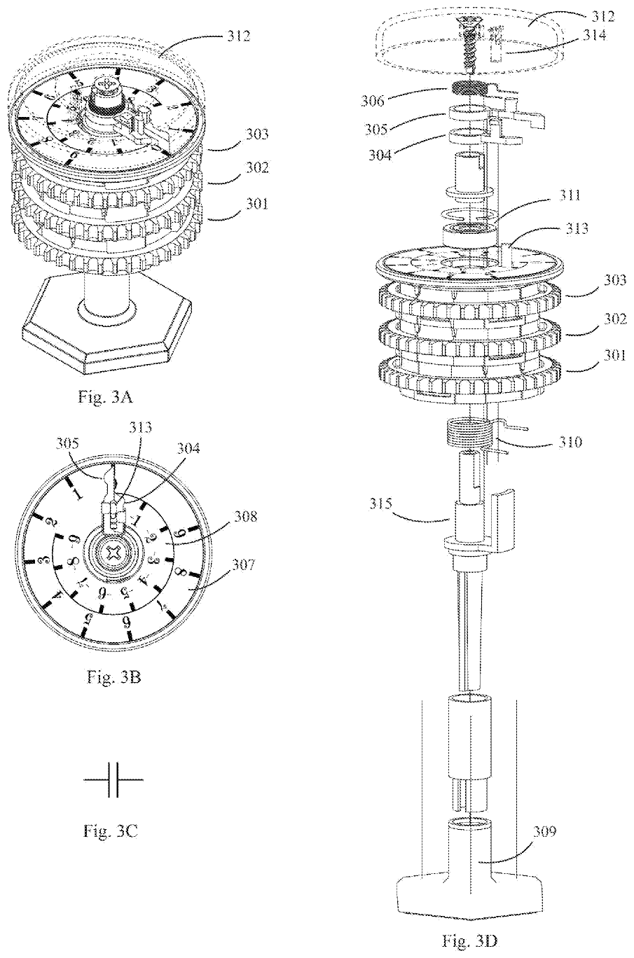

An embodiment of a mechanical capacitor, which also doubles as a spin Volt meter, is shown in FIG. 3A. The purpose of the mechanical capacitor is to store and release energy. In this embodiment, there are three sprockets, 301-303, that turn as one unit. As the sprockets are forced to turn, energy builds in the capacitor and the opposing force increases. When the sprockets are released, the capacitor turns back in the opposite direction.

FIG. 3D shows an exploded view of the mechanical capacitor. A magnetic base 309 is connected to the capacitor body 315. A torsion spring 310 slides over the capacitor body. The sprocket assembly (301-303) rotates on the capacitor body at bearing 311. When the sprocket assembly is turned, the torsion spring 310 stores energy and provides the return force.

An indicator on top of the mechanical capacitor shows the spin voltage across the capacitor through transparent cover 312. There are two sets of gradations on top of the capacitor: one that shows negative values (308) and one that shows positive values (307). A clockwise force is considered a positive voltage while a counter-clockwise force is considered a negative voltage. When the sprocket assembly is turned clockwise, protrusion 313 pushes against the short indicator hand 304, keeping it pointed at 0 while protrusion 314 pushes against the long indicator hand 305, forcing it to point to the positive voltage being applied to the capacitor. When the sprocket assembly is turned counter-clockwise, the long indicator hand 305 pushes against protrusion 313, keeping it pointed at 0, while protrusion 314 pushes against the short indicator hand 304, forcing it to point to the negative voltage being applied to the capacitor.

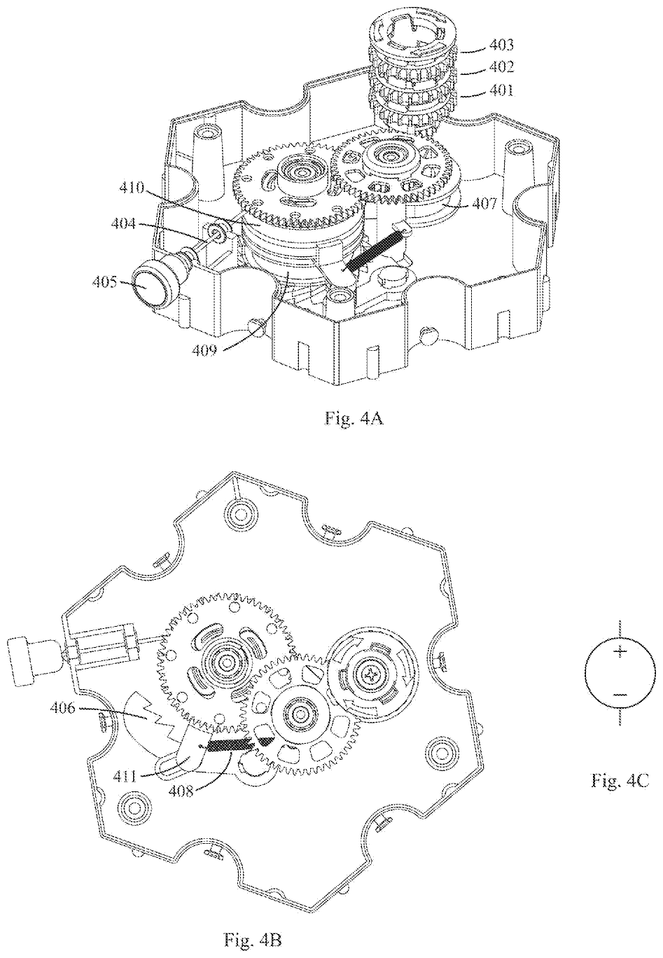

An embodiment of a mechanical battery is shown in FIG. 4A and FIG. 4B. The purpose of the mechanical battery is to provide power to mechanical circuits with a constant spin voltage. The motor is powered by a pull string 405/404 and a wind-up mechanism 407/409, though it could be powered by other mechanisms, for example an electrical motor, or the like. When the pull string handle 405 is pulled back, a constant force spring 407 is forced to wind around stack 409. When the string is released, the constant force spring forces (through intermediate gears) three sprockets 401-403 to turn together as one unit.

To avoid a situation where the mechanical battery releases its energy too quickly (i.e., a mechanical short), a mechanical analog of a circuit breaker is included. If stack 409 begins to turn too quickly in a clockwise direction, a small arm slides out of stack 409 due to centrifugal force and runs into arm 411, normally held back by extension spring 408. Arm 411 pushes pawl 406 into the base of stack 409, causing it to stop immediately.

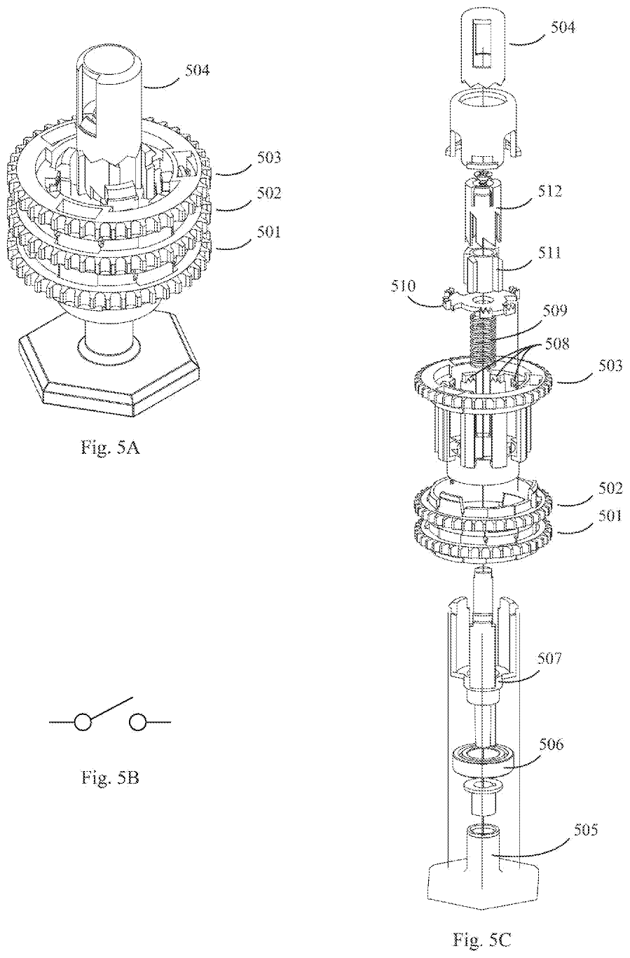

An embodiment of a mechanical switch is shown in FIG. 5A. The purpose of the mechanical switch is to be a source of very high resistance when not pressed and to be a source of very low resistance when pressed. That is, sprockets 501-503 do not turn when the button 504 is not pressed, but they turn easily when button 504 is pressed down.

FIG. 5C shows an exploded view of the mechanical switch, which works like the mechanism of a retractable pen. Magnetic base 505 is connected to the switch body 507, which is attached to the inner ring of bearing 506. The outer ring supports the sprocket 503, allowing it to rotate. Sprocket 503 snaps on to sprockets 502 and 501, making all three sprockets turn together as one. A spring 509 slides onto the switch body 507 and pushes upward on the brake 510, which pushes upward on cam 511. Cam 511 slides into the grooves of part 512, which is fixed to the top of switch body 507. The bottom of button 504 is the plunge, sliding up and down part 512 and pushing down on cam 511. When the button is pushed down so that it stays down, the grooves on brake 510 do not make contact with the internal grooves 508 on sprocket 503, making the resistance very low. However, when the button is pushed again and comes up, the grooves of brake 510 push into the internal grooves 508 and stop sprockets 501-503 from turning.

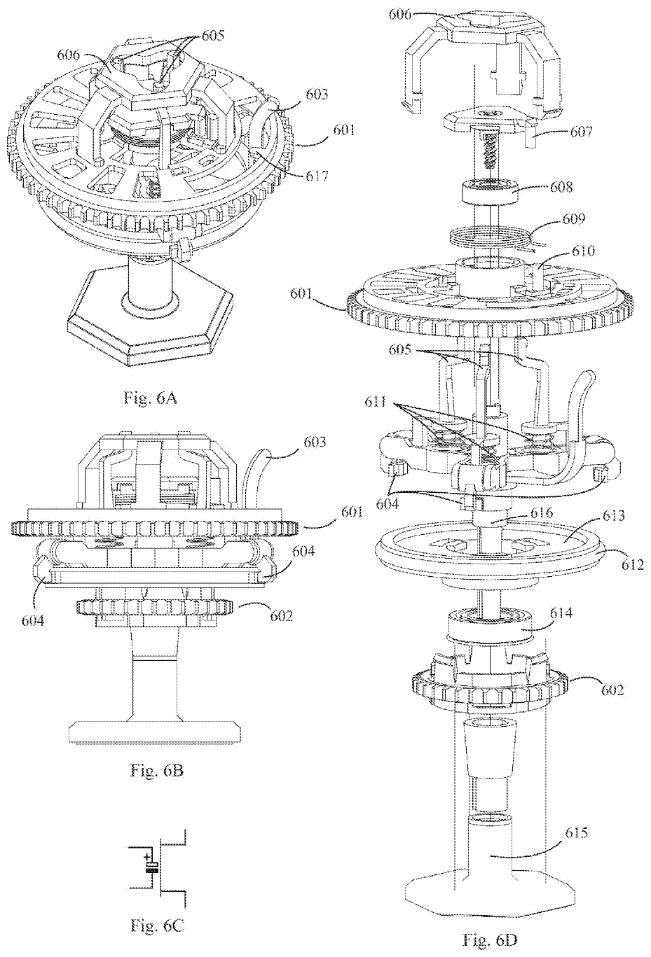

An embodiment of a mechanical transistor is shown in FIG. 6A. The mechanical transistor acts like a spin voltage-controlled resistor. The more the top sprocket 601 is turned, the lower the resistance of bottom sprocket 602. The top sprocket acts as a small capacitor itself—the more it is turned, the more return force it provides. The top sprocket can only turn clockwise or counterclockwise, and is determined by which side protrusion 617 is relative to limiter 603. It can be moved to the other side of 603 manually, by pushing 603 in toward the center of the transistor and then rotating sprocket 601 so protrusion 617 is on the other side.

The symbol for this mechanical transistor is shown in FIG. 6C, analogous to that of a Field Effect Transistor (FET). The gate is drawn as an electrolytic capacitor because it acts as a small capacitor to which only positive or negative spin voltage can be applied.

FIG. 6D shows an exploded view of the mechanical transistor. A magnetic base 615 connects to transistor body 616. Bearing 614 connects the transistor body 616 to brake disc 613, allowing it to rotate. Sprocket 602 is connected to brake disc 613 so that they turn together. Around brake disc 613 is a rubber ring 612 that creates friction when the three brake pads 604 push into it. At rest, springs 611 force the three brake pads 604 into the rubber ring 612. The gate sprocket 601 is connected to transistor body 616 through bearing 608, allowing it to rotate. Tower 606 is connected to gate 601, the inner surface of which acts as a guide for the three sliders 605. In this way, when the gate is turned, the sliders follow the inner surface of tower 606, which pushes them inward and releases the pressure of the brake pads 604 on the rubber ring 612.

When the gate 601 is forced to turn and then the force is removed, the gate returns back to its resting position, partly by force of springs 611 pushing against sliders 605 pushing against tower 606, and partly by torsion spring 609 squeezing protrusions 610 and 607 together.

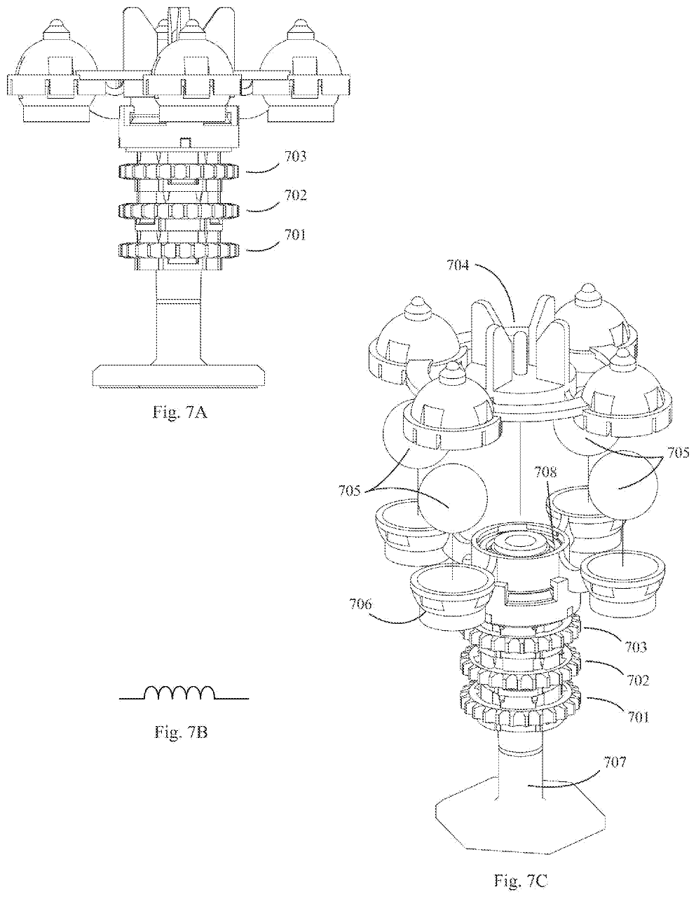

An embodiment of a mechanical inductor is shown in FIG. 7A. The purpose of the mechanical inductor is to impart momentum to current that flows through it, through sprockets 701-703, which are connected together and turn as one unit.

FIG. 7C shows a partially exploded view of the mechanical inductor. Bearing 708 connects the magnetic base 707 to the sprocket assembly that includes 701, 702, 703, and 706, allowing the assembly to rotate freely. Four steel balls 705 are sandwiched between part 706 and cap 704.

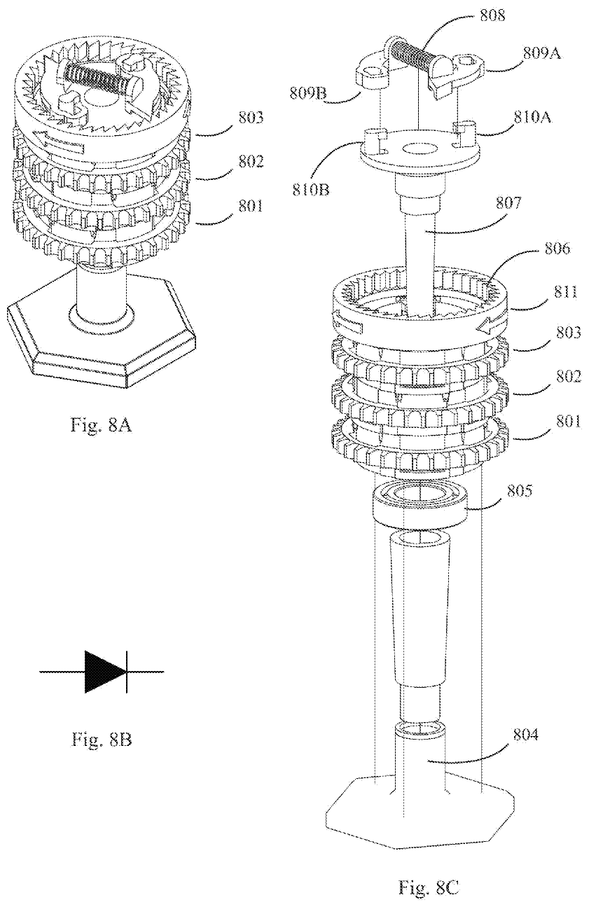

An embodiment of a mechanical diode is shown in FIG. 8A. The purpose of the mechanical diode is to allow current through sprockets 801-803 to only flow in one direction. FIG. 8C shows a partially exploded view of the mechanical diode. A magnetic base 804 is connected to the diode body 807. Bearing 805 connects to part 811, which is connected to sprockets 801-803 and allows the assembly to rotate. Protrusions 810A and 810B serve as an axle for the rotation of cams 809A and 809B. Spring 808 forces cams 809A and 809B apart and into the inner surface 806 of part 811. The inner surface 806 has asymmetric ridges that only allow cams 809A and 809B to slide in one direction, thus allowing the sprocket assembly to turn in only one direction.

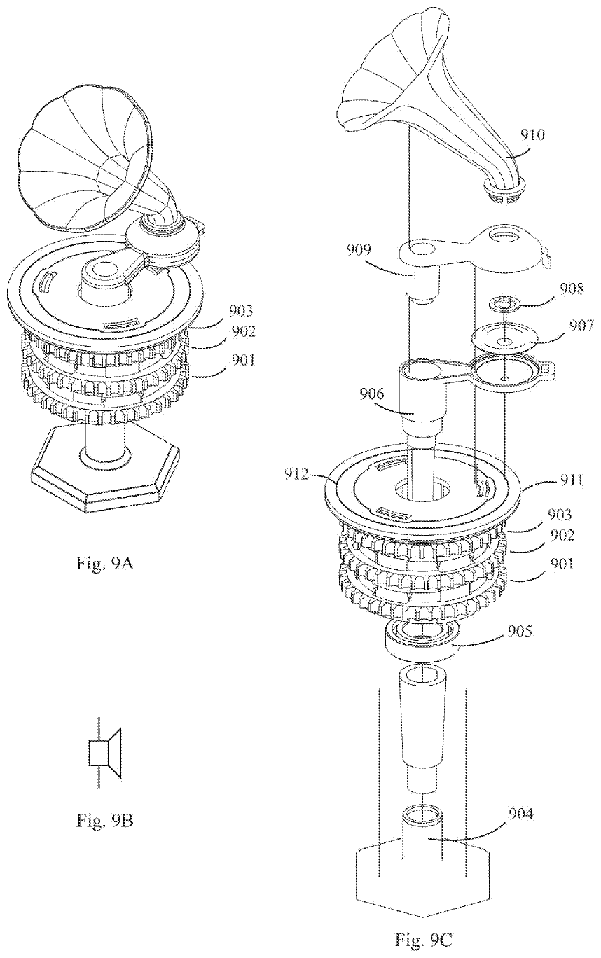

An embodiment of a mechanical tone generator/current meter is shown in FIG. 9A. The mechanical tone generator/current meter indicates current by making a sound with a pitch and volume that is proportional to the magnitude of the current.

FIG. 9C shows a partially exploded view of the mechanical tone generator/current meter. A magnetic base 904 is connected to the current meter body 906. The inner ring of bearing 905 is connected to the current meter body 906 and the outer ring is connected to disc 911, which is connected to the sprocket assembly 901, 902, and 903, allowing the sprocket assembly and disc 911 to rotate. A thin, plastic diaphragm 907 is attached to needle assembly 908, and the diaphragm lays in a recessed area in body 906. The recessed area has a hole in the bottom through which the needle protrudes. Cap 909 covers the top of body 906 and a horn 910 attaches to the cap. As disc 911 turns, the needle 908 drags through groove 912. Groove 912 has ridges that cause the needle 908 and the diaphragm 907 to vibrate, causing sound that travels through the horn and out into the surrounding air. The faster the sprockets 901-903 and disc 911 turn, the faster the vibrations and the higher the pitch noise it makes.

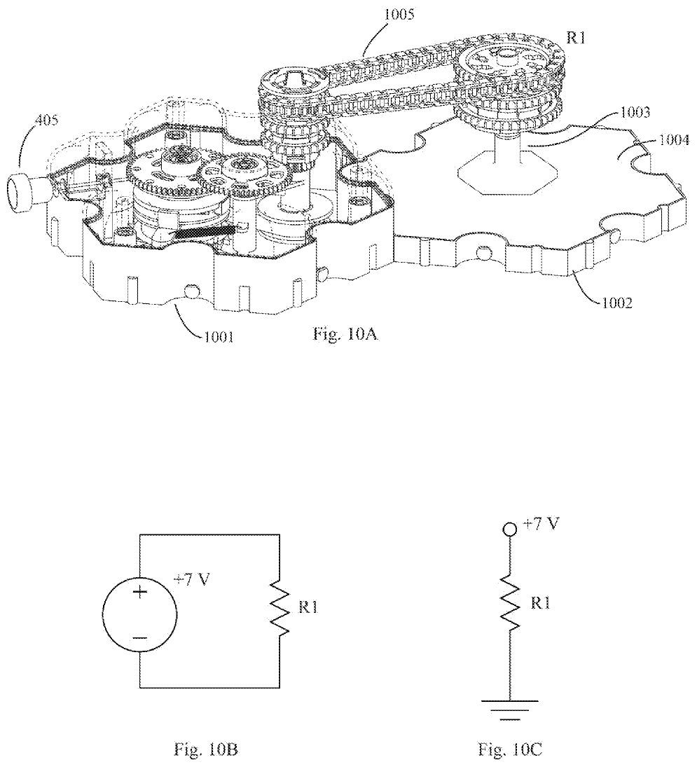

The mechanical resistor, capacitor, battery, switch, transistor, inductor, diode, and current meter are used together to build mechanical circuits, just as the analogous electronic components are used together to build electronic circuits. FIG. 10A shows a simple example of a circuit with a battery 1001 and a resistor 1003, connected in a circuit with chain 1005. When the pull-string handle for the battery 405 is pulled and released, the resistor 1003 (R1) turns at a constant angular velocity. The spin current can be calculated just as it would be in an electronic circuit using Ohm's Law. For example, if the resistor has a spin resistance of 1000 SΩ and the battery has a spin voltage of 7 SV, then the spin current will be 7 SV/1000 SΩ, or 0.007 SA.

The mechanical circuit of FIG. 10A may be represented in the circuit diagram format of FIG. 10B. The same circuit may also be drawn according to the more conventional circuit diagram of FIG. 10C. In this diagram, the mechanical analog of electrical ground was arbitrarily chosen to be where no force is pushing the chain.

The present embodiment also includes a method of arranging and holding the mechanical parts in place, which can be seen in FIG. 10A. A plurality of tiles 1002 form the base. Each tile can connect to other tiles or to a battery. The top of the tile 1004 is made of a metal to which the magnetic base of each part sticks and stays in place.

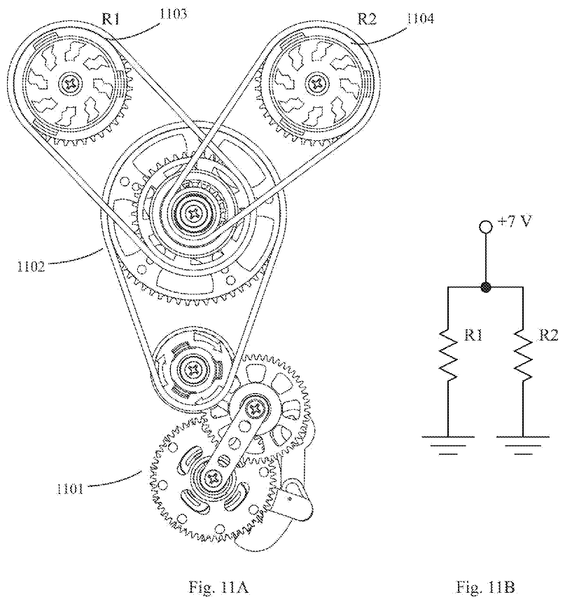

Four more examples of mechanical circuits will be shown. A simplified top view of a basic parallel circuit is shown in FIG. 11A. A 7 SV battery 1101 is connected to a junction 1102 that splits the current two ways. One branch puts 7 SV on resistor 1103 (R1) and the other branch puts 7 SV on resistor 1104 (R2). The mechanical circuit may be drawn in a conventional circuit diagram as FIG. 11B. The mechanical circuit behaves just like the electronic analog. The two branches are independent of one another. If one branch is stopped, the other branch continues with the same spin current, uninterrupted.

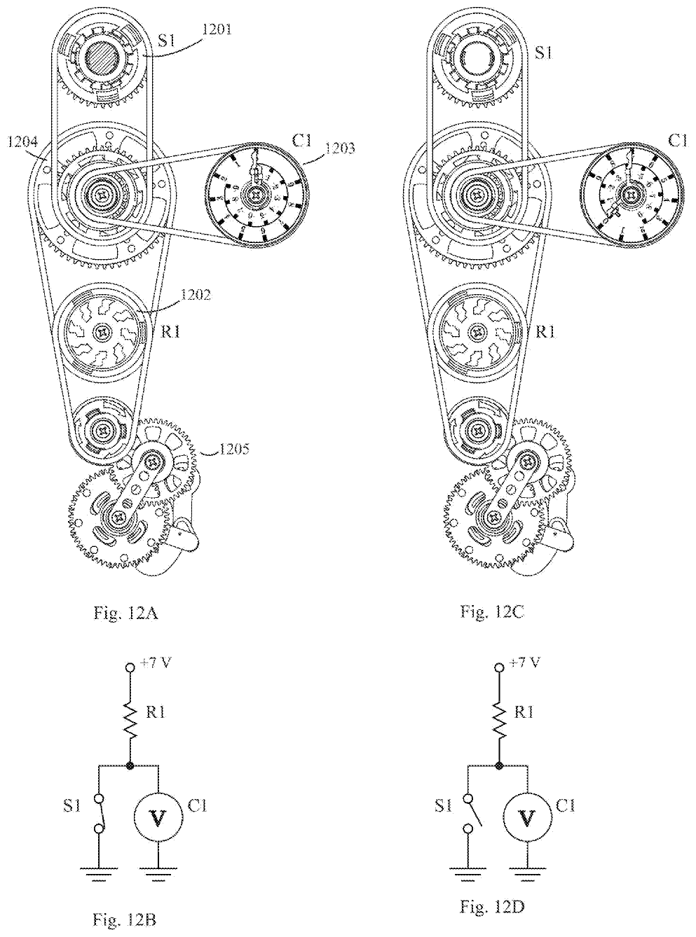

A simplified top view of a mechanical NOT gate is shown in FIG. 12A, where the input switch 1201 (S1) is set to ON, and in FIG. 12C, where the input switch (S1) is set to OFF. FIG. 12B and FIG. 12D show the conventional circuit diagrams of the circuits in FIG. 12A and the FIG. 12C, respectively. The output of the NOT gate is indicated by spin voltmeter 1203 (C1). The circuit is a mechanical voltage divider, with resistor 1202 (R1) on top and switch 1201 (S1) on the bottom. When the switch is ON, as in FIG. 12A, its spin resistance is extremely low and the spin voltage between the switch and resistor becomes nearly zero. When the switch is OFF, as in FIG. 12C, its spin resistance is extremely high and the spin voltage between the switch and resistor becomes nearly the same as the battery.

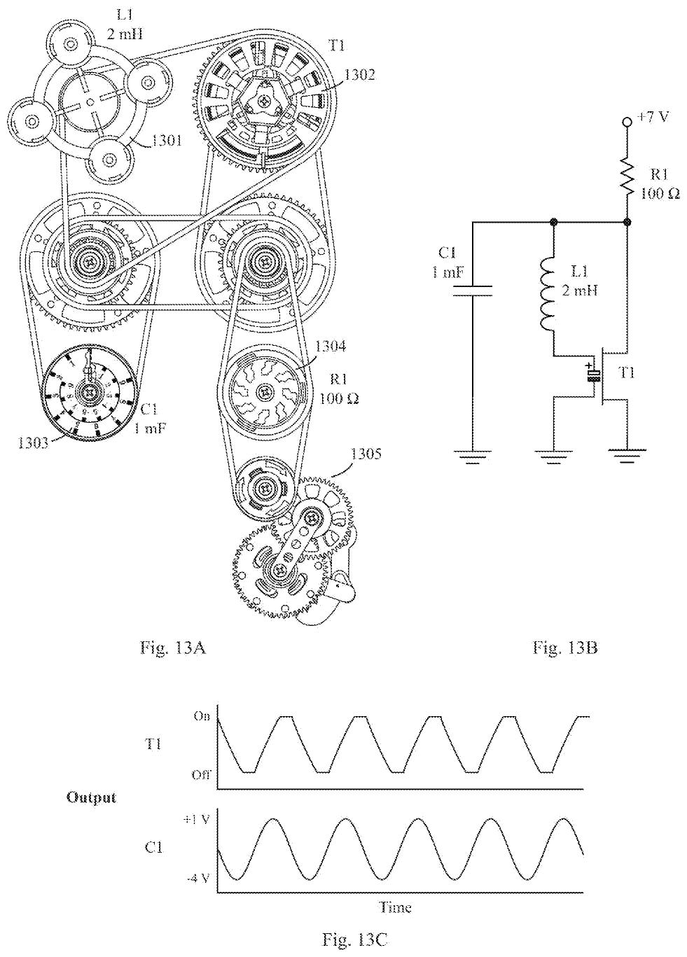

A simplified top view of a mechanical oscillator is shown in FIG. 13A, with the corresponding circuit diagram in FIG. 13B. The output of the mechanical circuit is shown in FIG. 13C. To understand this circuit, first notice the NOT gate formed by resistor 1304 (R1) and transistor 1302 (T1): When T1 is on, the spin voltage between the resistor and transistor is low. When T1 is off, the spin voltage between the resistor and transistor is high. Feedback is provided by sending the output of the NOT gate to the gate of the transistor T1. In this way, when T1 is off, it is forced to turn back on, and when T1 is on, it is forced to turn back off. Thus, it oscillates. The inductor 1301 (L1) and capacitor 1303 (C1) form an LC circuit in the path of feedback that controls the frequency of the oscillations.

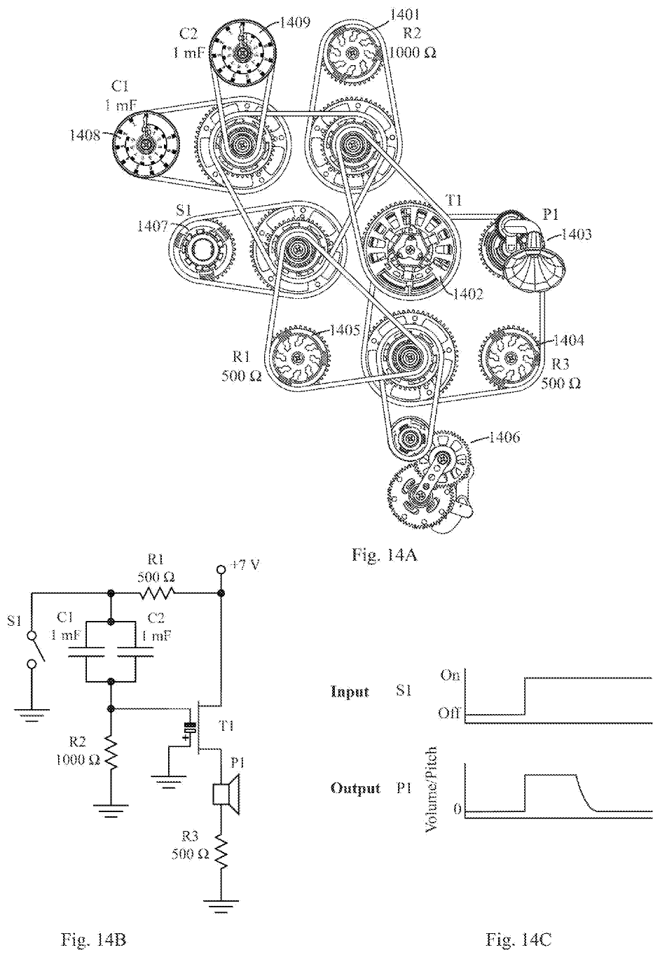

A simplified top view of a mechanical delay circuit is shown in FIG. 14A, with the corresponding conventional circuit diagram in FIG. 14B. Given the input shown in the top of FIG. 14C, the output of the circuit is shown in the bottom of FIG. 14C. Switch 1407 (S1) begins in the OFF position. Capacitors 1408 and 1409 (C1 and C2) charge through resistors 1405 (R1) and 1401 (R2). When S1 is pushed, the positive side of the capacitors is brought to ground, putting a negative spin voltage on the gate of T1, turning T1 on and thereby causing the current meter 1403 (P1) to make noise. The pitch of the noise is determined by resistor 1404 (R3). Capacitors C1 and C2 begin to discharge through R2, but T1 remains on until the spin voltage across the gate of T1 drops below the threshold voltage. At that point, T1 turns off and the current meter P1 stops making noise.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed is:

1. A mechanical analog of electronics configured to enable the construction of a mechanical equivalent of an electrical circuit, the mechanical analog of electronics comprising:
two or more repositionable rotating members, each of rotating member representing a mechanical equivalent of a component of an electrical circuit, wherein the rotating members are operably coupled together by at least one of a chain, belt, string, or gear coupling.

2. The mechanical analog of electronics of claim 1, wherein each rotating member represents an mechanical analog of at least one of an electrical junction, resistor, capacitor, battery, switch, transistor, inductor, diode, or tone generator.

3. The mechanical analog of electronics of claim 1, wherein at least one of the rotating members represents a mechanical analog of an electrical junction comprising a differential gear system including a first gear, sprocket or pulley, a second gear, sprocket or pulley and a third gear, sprocket or pulley, wherein a velocity on a perimeter of the first gear, sprocket or pulley is equal to a velocity on a perimeter of the second gear, sprocket or pulley plus a velocity on a perimeter of the third gear, sprocket or pulley.

4. The mechanical analog of electronics of claim 1, wherein at least one of the rotating members represents a mechanical analog of electrical resistor comprising at least one rotatable gear, sprocket or pulley operably coupled to a spindle, and a viscous fluid damper configured to enable the spindle to rotate with a fixed resistance as a result of shearing of the viscous fluid.

5. The mechanical analog of electronics of claim 1, wherein at least one of the rotating members represents a mechanical analog of a mechanical capacitor configured to enable measurement of a voltage in a mechanical equivalent of an electrical circuit, the mechanical capacitor comprising at least one rotatable gear, sprocket or pulley and a torsion spring, wherein rotation of the at least one rotatable gear, sprocket or pulley causes energy to be stored in the torsion spring, the mechanical capacitor further comprising an indicator configured to display an amount of energy stored in the torsion spring.

6. The mechanical analog of electronics of claim 1, wherein at least one of the rotating members represents a mechanical tone generator configured to enable measurement of the flow of current in a mechanical equivalent of electrical circuit, the mechanical tone generator comprising at least one rotating gear, sprocket or pulley and a diaphragm, wherein rotation of the at least one rotatable gear, sprocket or pulley causes a vibration in the diaphragm resulting in an audible noise, wherein a pitch of the audible noise varies according to an angular velocity of the at least one gear, sprocket or pulley.

7. The mechanical analog of electronics of claim 1, wherein at least one of the rotating members represents a mechanical analog of electrical transistor comprising a first rotatable gear, sprocket or pulley, a second rotatable gear, sprocket or pulley and a brake mechanism operably coupled to the second rotatable gear, sprocket or pulley configured to provide a resistance to rotation of the second rotatable gear, sprocket or pulley, wherein rotation of the first rotatable gear, sprocket or pulley causes at least one of an increase or a decrease in the resistance to rotation of the second rotatable gear, sprocket or pulley.

8. The mechanical analog of electronics of claim 1, further comprising a ferritic base, wherein each of the rotating members is configured to rotate relative to a stationary magnetic base selectively and magnetically coupleable to the ferritic base.

9. A mechanical analog of an electrical junction comprising:
a differential gear system comprising a first gear, sprocket or pulley, a second gear, sprocket or pulley and a third gear, sprocket or pulley, wherein a velocity on a perimeter of the first gear, sprocket or pulley is equal to a velocity on a perimeter of the second gear, sprocket or pulley plus a velocity on a perimeter of the third gear, sprocket or pulley.

10. The mechanical analog of an electrical junction of claim 9, wherein the differential gear system comprises a sun and planetary gear system.

11. The mechanical analog of an electrical junction of claim 9, wherein the velocity of the perimeter of the first gear, sprocket or pulley represents an electrical current flowing into an electrical junction, and the velocity of the perimeter of the second third gear, sprocket or pulley and the velocity of the perimeter of the third gear, sprocket or pulley represent electrical currents flowing out of the electrical junction.

12. The mechanical analog of an electrical junction of claim 9, wherein the first gear, sprocket or pulley is three times larger than the third gear, sprocket or pulley.

13. The mechanical analog of an electrical junction of claim 9, wherein the second gear, sprocket or pulley is two times larger than the third gear, sprocket or pulley.

14. The mechanical analog of an electrical junction of claim 9, further comprising a ferritic base, wherein the differential gear system is configured to rotate relative to a stationary magnetic base selectively and magnetically coupleable to the ferritic base.

15. A mechanical analog of electronics configured to enable the construction of a mechanical equivalent of an electrical circuit, the mechanical analog of electronics comprising:
at least one rotating member representing a mechanical equivalent of a component of an electrical circuit, wherein the at least one rotating member is configured to rotate relative to a stationary magnetic base; and
a ferritic base, wherein the at least one rotating members selectively, magnetically coupleable to the ferritic base.

16. The mechanical analog of electronics of claim 15, wherein the at least one rotating member represents a mechanical analog of an electrical junction comprising a differential gear system including a first sprocket, a second sprocket and a third sprocket, wherein a velocity on a perimeter of the first sprocket is equal to a velocity on a perimeter of the second sprocket plus a velocity on a perimeter of the third sprocket.

17. The mechanical analog of electronics of claim 15, wherein the at least one rotating member represents a mechanical analog of electrical resistor comprising at least one rotatable gear, sprocket or pulley operably coupled to a spindle, and a viscous fluid damper configured to enable the spindle to rotate with a fixed resistance as a result of shearing of the viscous fluid.

18. The mechanical analog of electronics of claim 15, wherein the at least one rotating member represents a mechanical analog of a mechanical capacitor configured to enable measurement of a voltage in a mechanical equivalent of an electrical circuit, the mechanical capacitor comprising at least one rotatable gear, sprocket or pulley and a torsion spring, wherein rotation of the at least one rotatable gear, sprocket or pulley causes energy to be stored in the torsion spring, the mechanical capacitor further comprising an indicator configured to display an amount of energy stored in the torsion spring.

19. The mechanical analog of electronics of claim 15, wherein the at least one of the rotating member represents a mechanical tone generator configured to enable measurement of the flow of current in a mechanical equivalent of electrical circuit, the mechanical tone generator comprising at least one rotating gear, sprocket or pulley and a diaphragm, wherein rotation of the at least one rotatable gear, sprocket or pulley causes a vibration in the diaphragm resulting in an audible noise, wherein a pitch of the audible noise varies according to an angular velocity of the at least one gear, sprocket or pulley.

20. The mechanical analog of electronics of claim 15, wherein the at least one rotating members represents a mechanical analog of electrical transistor comprising a first rotatable gear, sprocket or pulley, a second rotatable gear, sprocket or pulley and a brake mechanism operably coupled to the second rotatable gear, sprocket or pulley configured to provide a resistance to rotation of the second rotatable gear, sprocket or pulley, wherein rotation of the first rotatable gear, sprocket or pulley causes at least one of an increase or a decrease in the resistance to rotation of the second rotatable gear, sprocket or pulley.
